(19) United States
(12) Patent Application Publication
(10) Pub. No.: US 2013/0075661 A1
(43) Pub. Date: Mar. 28, 2013

(54) SILICATE LUMINOUS MATERIAL AND PREPARATION METHOD THEREOF

(71) Applicants: Mingjie Zhou, Guangdong (CN); Rong Wang, Guangdong (CN); Wenbo Ma, Guangdong (CN)

(72) Inventors: Mingjie Zhou, Guangdong (CN); Rong Wang, Guangdong (CN); Wenbo Ma, Guangdong (CN)

(73) Assignee: Ocean's King Lighting Science & Technology Co., Ltd., Guangdong (CN)

(21) Appl. No.: 13/702,142

(22) PCT Filed: Jun. 13, 2010
(86) PCT No.: PCT/CN2010/073986

§ 371 Date: Dec. 5, 2012

(51) Int. Cl. C09K 11/59; C09K 11/87

(52) U.S. Cl. CPC C09K 11/595; C09K 11/876
USPC 252/301.6 F

(57) ABSTRACT

Silicate luminous material and preparation method thereof are provided. The luminous material is represented by the following chemical formula: Zn₂₋ₓSiO₄:Mnₓ@SiO₂@M_{y}, wherein M represents at least one element selected from the group consisting of Ag, Au, Pt, Pd and Cu, and y is molar ratio of M to Si in silicate luminous materials, and 0<x≦0.2, 0<y≦1×10⁻². @ is coating; M is inner core; SiO₂ is middle shell; Zn₂₋ₓSiO₄:Mnₓ is outer shell. The core-shell luminous materials coating metal particle improve internal quantum efficiency, increase luminous intensity, and they are stable. The luminous materials can be controlled in the aspects of size and appearance and are appropriate to be used in coating screen process and improving display effect for sphere appearance with bulk density. Precipitation methods can not only decrease reaction temperature, but also have features of simple process, low equipment requirement, non-pollution and are controlled easily.

### FIELD OF THE INVENTION

The present invention relates to the fields of luminescent materials and lighting technology, more particularly, relates to a silicate luminous material and a preparation method thereof.

### BACKGROUND OF THE INVENTION

The luminescent properties of a silicate luminous material is relates to its morphology and particle size. Spherical and spherical-like luminous materials, as well as luminous materials with Particle uniformity between 3.0 to 5.0 μm always have high illumination intensity, and easy to apply. However, traditional luminous materials are manufactured by high temperature solid state method, the granularity is uneven, and needing many times of ball mill to gain appropriate particle size, the defects of ball mill process and the impurity produced damaged the illumination intensity, and thus disadvantage in application.

### SUMMARY OF THE INVENTION

Based on this, it is necessary to provide a uniform size distribution, high illumination intensity of silicate luminous materials.

A silicate luminous material which is represented by the following chemical formula: Zn₂₋ₓSiO₄:Mnₓ@SiO₂@M_{y}, in which @ is coating, M is inner core, SiO₂ is middle shell, Zn₂₋ₓSiO₄:Mnₓ is outer shell; M is a metal selected at least one from the group consisting of Ag, Au, Pt, Pd and Cu; y is molar ratio of M to Si in the silicate luminous material; and, the scope of x is: 0<x≦0.2, the scope of y is 0<y≦1 ×10⁻².

Preferably, the scope of x is 0.02≦x≦0.10, the scope of y is 1×10⁻⁵≦y≦5×10⁻³.

In addition, due to the defects in traditional high temperature solid state method, it is necessary to provide a preparation method to get spherical silicate luminous materials.

A preparation method of silicate luminous material, includes the steps of: A) mixing a salt solution containing M, an addition agent solution for stabilizing and dispersing, and a reducing agent solution, reacting to obtain a collosol containing M nano-particle; and M is a metal selected at least one from the group consisting of Ag, Au, Pt, Pd and Cu; B) adding the collosol containing M nano-particle into PVP (i.e., polyvinylpyrrolidone) aqueous solution for M nano-particle surface treating, then coating SiO₂ nanosphere by StÖmethod, to obtain a SiO₂@M sol suspension; C) introducing a Zn salt solution and a Mn salt solution into the SiO₂@M sol suspension, the amount of Zn and Mn element is according to stoichiometric ratio of chemical formula Zn₂₋ₓSiO₄:Mnₓ@SiO₂@M_{y}, and the scope of x is 0.02≦x≦0.10, the scope of y is 1×10⁻⁵≦y≦5×10⁻³; and, adding a precipitating agent into the suspension, then filtering, washing and drying the generated precipitate, to obtain a precursor; and, drying the precursor for 2 to 10 hours, and heat treatment in reducing atmosphere, then cooling to obtain the silicate luminous material Zn₂₋ₓSiO₄:Mnₓ@SiO₂@M_{y}; wherein @ is coating, M is inner core, SiO₂ is middle shell, Zn₂₋ₓSiO₄:Mnₓ is outer shell.

Preferably, the step A further including the step of preparing the salt solution containing M, which is,

providing raw material of M-salt, adding into deionized water or ethanol, then stirring to obtain the salt solution containing M with concentration from 1×10⁻³ mol/L to 5×10⁻³ mol/L; the raw material of M-salt is selected at least one from the group consisting of AgNO₃, AuCl₃.HCl.4H₂O, H₂PtCl₆.6H₂O, PdCl₂.2H₂O, and Cu(NO₃)₂.

Preferably, in step A, the addition agent is selected at least one from the group consisting of PVP, sodium citrate, cetyltrimethyl ammonium bromide, sodium dodecyl sulfate, and sodium dodecyl sulfonate; and the content of addition agent in the collosol containing M nano-particle is from 1×10⁻⁴ g/ml to 5×10⁻² g/ml; and the concentration of the reducing agent solution is from 1×10⁻⁴ mol/L to 1.0 mol/L, the reducing agent is selected at least one from the group consisting of hydrazine hydrate, ascorbic acid, sodium citrate, and sodium borohydride; and the molar ratio of reducing agent to M is from 3.6:1 to 18:1.

Preferably, in step B, the concentration of the PVP aqueous solution is from 0.005 g/ml to 0.1 g/ml.

Further in step B, the processing of coating SiO₂ nanosphere by StÖber method includes: adding absolute ethanol, deionized water, aqueous ammonia, and TEOS (i.e., tetraethyl orthosilicate) one after another into the collosol containing M nano-particle, stirring to obtain the SiO₂@M sol suspension.

Preferably, in step C, prior to introducing a Zn salt solution and a Mn salt solution into the SiO₂@M sol suspension, pH value of the SiO₂@M sol suspension.is adjusted to 3.0 to 3.5.

Preferably, in step C, the Zn salt solution is selected from the group of Zn solution consisting of nitrate, acetate, sulfate, and hydrochloride; the Mn salt is selected from the group of Mn solution consisting of nitrate, acetate, sulfate, and hydrochloride; the stoichiometric ratio of Zn and Mn to Si is (Zn+Mn):Si≦1:2; the precipitating agent is ammonium oxalate, the amount of ammonium oxalate is 125% to the total moles of Zn₂₋ₓSiO₄:Mnₓ@SiO₂@M_{y} suspension.

Preferably, in step S3, the heat treatment is under temperature around 1000° C. to 1300° C., and treating for 1 to 6 hours.

Preferably, the reducing atmosphere is selected from the group consisting of N₂ and H₂ mixed reduction atmosphere, CO reduction atmosphere, and H₂ reduction atmosphere.

The above-mentioned silicate luminescent material, by coating metal particle to form a core-shell structure, improves inner quantum efficiency of the silicate, and by adding metal nano-particles, strengthens luminous intensity of the silicate; furthermore, the luminescent material has good stability, has spherical morphology, and the size and morphology can be controlled; as spherical morphology has higher bulk density, it is facilitate in coating and improves the display effect.

At the same time, by using the aforesaid precipitation method, it can get epigranular, core-shell structured, spherical morphology of luminescent material; and by this method, it reduces reaction temperature, simplifies preparation technology, decreases equipment requirements, and no pollution, easy to control.

### BRIEF DESCRIPTION OF THE DRAWINGS

FIG. 1 shows the comparison CL emission spectrum of the luminescent materials at the condition of the accelerate voltage is 1.5 kv, according to example 3; curve 1 is the spectrum of luminescent material Zn_{1.96}SiO₄:Mn_{0.04}@Ag_{2.5×10}₁₀⁻⁴, and curve 2 is the spectrum of commercial obtained luminescent material Zn₂SiO₄:Mn.

### DETAILED DESCRIPTION

A silicate luminescent material, by coating metal nano-particle to form a core-shell structure, improves inner quantum efficiency of the luminescent material, and with high luminous intensity and good stability.

The silicate luminescent material can be used as green fluorescent powder in field emission devices, the structure is represented by the following chemical formula: Zn₂₋ₓSiO₄:Mnₓ@SiO₂@M_{y}, in which @ is coating, M is inner core, SiO₂ is middle shell, Zn₂₋ₓSiO₄:Mnₓ is outer shell; M is a metal selected at least one from the group consisting of Ag, Au, Pt, Pd and Cu; y is molar ratio of M to Si in the silicate luminous material; and, the scope of x is: 0<x≦0.2, the scope of y is 0<y≦1×10⁻².

This invention further provided a preparation method of silicate luminous material, comprising the steps of:

Firstly, mixing a salt solution containing M, an addition agent solution for stabilizing and dispersing, and a reducing agent solution, reaction to obtain a collosol containing M nano-particle; in details as following:

(1). preparing salt solution containing M with concentration from 1×10⁻³ mol/L to 5×10⁻³ mol/L, the salt solution containing M is selected at least one from AgNO₃, AuCl₃.HCl.4H₂O, H₂PtCl₆.6H₂O, PdCl₂.2H₂O, or Cu(NO₃)₂, the solvent is deionized water or ethanol, and M is selected at least one from Ag, Au, Pt, Pd, or Cu.

(2). with magnetic stirring, dissolving at least one addition agent into the prepared salt solution containing M, the content of addition agent in the collosol containing M nano-particle is from 1×10⁻⁴ g/ml to 5×10⁻² g/ml; the addition agent is selected at least one from PVP, sodium citrate, cetyltrimethyl ammonium bromide, sodium dodecyl sulfate, or sodium dodecyl sulfonate;

(3). preparing a reducing agent with concentration from 1×10⁻⁴ mol/L to 1.0 mol/L, the reducing agent is selected at least one from hydrazine hydrate, ascorbic acid, sodium citrate, or sodium borohydride, and the solvent is deionized water or ethanol;

(4). with magnetic stirring, adding the M-salt solution prepared in step (2) into the reducing agent solution prepared in step (3), according to the molar ratio of reducing agent to M is from 3.6:1 to 18:1; the reaction for 10 min to 45 min to obtain collosol containing M nano-particle.

Next, adding the collosol containing M nano-particle into PVP aqueous solution, for M nano-particle surface treating, then coating SiO₂ nanosphere by StÖber method, to obtain a SiO₂@M sol suspension; in details as following:

(1). adding PVP into the collosol containing M nano-particle, according to the volume of the collosol, stirring for 3 hours to 24 hours in room temperature, to obtain the collosol with concentration of PVP from 0.005 g/ml to 0.1 g/ml;

(2). adding TEOS into a mixture to arise condensation—condensation reaction, the mixture containing deionized water, surface treated collosol containing M nano-particle, absolute ethanol, and aqueous ammonia; after 3 hours to 12 hours reaction, a milk-white SiO₂@M sol suspension is obtained.

Finally, introducing a Zn salt solution and a Mn salt solution into the SiO₂@M sol suspension, the amount of Zn and Mn element is according to stoichiometric ratio of chemical formula Zn₂₋ₓSiO₄:Mnₓ; adding a precipitating agent into the suspension, washing and drying the generated precipitate to obtain a precursor; heat treating and reduce treating the precursor, then cooling, to obtain the silicate luminous material Zn₂₋ₓSiO₄:Mnₓ@SiO₂@M_{y}; in details as following:

(1). adjusting pH value between 3.0 to 3.5 of the SiO₂@M sol suspension, then adding into salt solution containing Zn and Mn, preferred salt solution is nitrate solution, acetate solution, sulfate solution, and/or hydrochloride solution; the stoichiometric ratio of Zn and Mn to Si is (Zn+Mn):Si≦1:2.

(2). adding ammonium oxalate to act as precipitating agent, once white precipitate generated, stirring, ageing and filtering it, then washing the precipitate by deionized water and absolute alcohol for two to three times, drying and obtain the premonitory; in prefer, the amount of ammonium oxalate is 125% to the total moles of Zn₂₋ₓSiO₄:Mnₓ@SiO₂@M_{y} suspension, thus to ensure thoroughly precipitate.

(3). putting the premonitory into the muffle for heat treatment 2 to 10 hours under temperature of 1000° C. to 1300° C.

(4). then transferring the premonitory into a reducing atmosphere for reducing 1 to 6 hours under temperature of 1000° C. to 1300° C., the reducing atmosphere reducing atmosphere is selected from N₂ and H₂ mixed reduction atmosphere, CO reduction atmosphere, or H₂ reduction atmosphere.

Then, the present invention is combination with specific examples to illustrate the silicate luminescent material of different composition, and its preparation method, and the test of performance and other aspects.

### Example 1

### Preparation of Zn_{1.92}SiO₄:Mn_{0.08}@SiO₂@Au_{1×10}⁻² by Precipitation Coating Method

Preparation of Au nano-particle sol: Weigh accurately about 20.6 mg AuCl₃.HCl.4H₂O and dissolve into 16.8 ml deionized water; after the chloroauric acid dissolved thoroughly, weigh accurately about 14.0 mg sodium citrate, 6.0 mg CTAB (i.e., cetyl trimethyl ammonium bromide), and dissolve into the chloroauric acid aqueous solution by magnetic stirring; weigh accurately about 1.9 mg sodium borohydride, 17.6 mg ascorbic acid and dissolve into 10.0 ml deionized water separately, get a sodium borohydride solution with concentration of 5×10⁻³ mol/L, and a ascorbic acid solution with concentration of 1×10 ⁻² mol/L; with magnetic stirring, introducing 0.08 ml sodium borohydride solution into the chloroauric acid aqueous solution, stirring and reaction for 5 minutes, then introducing 3.12 ml ascorbic acid solution and reaction for 30 minutes, and get 20.0 ml Au nano-particle sol with concentration of 5×10⁻³ mol/L; measuring and taking 10.0 ml Au nano-particle sol with concentration of 5×10⁻³ mol/L into a beaker, adding 2.0 ml PVP solution with concentration of 0.1 g/ml, magnetic stirring for 8 hours, finally get Au nano-particle after surface treatment.

Preparation of Zn_{1.92}SiO₄:Mn_{0.08}@SiO₂@Au_{1×10}⁻² : By stirring, adding 25.0 ml absolute ethanol, 5.0 ml aqueous ammonia, and 1.2 ml TEOS one after another into the Au nano-particle sol, and reaction for 8 hours, then adjusting the pH value of the solution with 3.0 to 3.5; introducing 4.8 ml Zn(NO₃)₂ with concentration of 2.0 mol/L, 4.0 ml Mn (NO₃)₂ with concentration of 0.1 mol/L, stirring, dropping 12.0 ml ammonium oxalate solution with concentration of 1.0 mol/L and generated white precipitate; then stirring for 1.5 hours, ageing, filtering, and washing the precipitate by deionized water and absolute alcohol for three times, drying and obtain a premonitory; putting the premonitory into the muffle for heat treatment 4 hours under temperature of 1300° C., then transfer into a tube furnace roasting for 2 hours under temperature of 1100° C. in 95% N₂+5% H₂ mixed reducing atmosphere; cooling to room temperature, finally obtain the luminescent material Zn_{1.92}SiO₄:Mn_{0.08}@SiO₂@Au_{1×10}⁻².

### Example 2

### Preparation of Zn_{1.98}SiO₄:Mn_{0.02}@SiO₂@Pt_{5×10}⁻³ by Precipitation Coating Method

Preparation of Pt nano-particle sol: Weigh accurately about 25.9 mg H₂PtCl₆.6H₂O and dissolve into 17.0 ml deionized water; after the chloroplatinic acid dissolved thoroughly, weigh accurately about 40.0 mg sodium citrate, 60.0 mg sodium dodecylsulphate, and dissolve into the chloroplatinic acid aqueous solution by magnetic stirring; weigh accurately about 1.9 mg sodium borohydride to dissolve into 10.0 ml deionized water, get 10.0 ml sodium borohydride solution with concentration of 5×10⁻³ mol/L; and preparing 10.0 ml hydrazine hydrate solution with concentration of 5×10⁻² mol/L; with magnetic stirring, introducing 0.4 ml sodium borohydride solution into the chloroplatinic acid aqueous solution, stirring and reaction for 5 minutes, then introducing 2.6 ml hydrazine hydrate solution and reaction for 40 minutes, and get 10.0 ml Pt nano-particle sol with concentration of 2.5×10⁻³ mol/L; measuring and taking 8.0 ml Pt nano-particle sol with concentration of 2.5×10⁻³ mol/L into a beaker, adding 4.0 ml PVP solution with concentration of 0.02 g/ml, magnetic stirring for 18 hours, finally get Pt nano-particle after surface treatment.

Preparation of Zn_{1.98}SiO₄:Mn_{0.02}@SiO₂@Pt_{5×10}⁻³: By stirring, adding 20.0 ml absolute ethanol, 4.0 ml aqueous ammonia, and 1.0 ml TEOS one after another into the Pt nano-particle sol, and reaction for 3 hours, then adjusting the pH value of the solution with 3.0 to 3.5; introducing 7.92 ml ZnCl₂ with concentration of 1.0 mol/L, 4.0 ml MnCl₂ with concentration of 0.02 mol/L, stirring, dropping 25.0 ml ammonium oxalate solution with concentration of 0.5 mol/L and generated white precipitate; then stirring for 2 hours, ageing, filtering, and washing the precipitate by deionized water and absolute alcohol for three times, drying and obtain a premonitory; putting the premonitory into the muffle for heat treatment 10 hours under temperature of 1000° C., then roasting and reducing for 6 hours under temperature of 1000° C. in CO reducing atmosphere; cooling to room temperature, finally obtain the luminescent material Zn_{1.98}SiO₄:Mn_{0.02}@SiO₂@Pt_{5×10}⁻³.

### Example 3

### Preparation of Zn_{1.96}SiO₄:Mn_{0.04}@SiO₂@Ag_{2.5×10}⁻⁴ by Precipitation Coating Method

Preparation of Ag nano-particle sol: Weigh accurately about 3.4 mg AgNO₃ and dissolve into 18.4 ml deionized water; after AgNO₃ dissolved thoroughly, weigh accurately about 42.0 mg sodium citrate dissolve into silver nitrate acid aqueous solution by magnetic stirring; weigh accurately about 5.7 mg sodium borohydride to dissolve into 10.0 ml deionized water, get 10.0 ml sodium borohydride solution with concentration of 1.5×10⁻² mol/L; with magnetic stirring, introducing 1.6 ml 1.5×10⁻² mol/L sodium borohydride solution into the silver nitrate aqueous solution, reaction for 10 minutes to get 20.0 ml Ag nano-particle sol with concentration of 1×10⁻³ mol/L; measuring and taking 1.2 ml Ag nano-particle sol with concentration of 1×10⁻³ mol/L into a beaker, adding 10 ml PVP solution with concentration of 0.01 g/ml, magnetic stirring for 12 hours, finally get Ag nano-particle after surface treatment.

Preparation of Zn_{1.96}SiO₄:Mn_{0.04}@SiO₂@Ag_{2.5×10}⁻⁴: By stirring, adding 30.0 ml absolute ethanol, 7.2 ml aqueous ammonia, and 1.2 ml TEOS one after another into the Ag nano-particle sol, and reaction for 6 hours, then adjusting the pH value of the solution with 3.0 to 3.5; introducing 9.8 ml Zn(NO₃)₂ with concentration of 1.0 mol/L, 4.0m l Mn(CH₃COO)₂ with concentration of 0.05 mol/L, stirring, and dropping 40.0 ml ammonium oxalate solution with concentration of 0.4 mol/L, then generated white precipitate; then stirring for 3 hours, ageing, filtering, and washing the precipitate by deionized water and absolute alcohol for three times, drying and obtain a premonitory; putting the premonitory into the muffle for heat treatment 4 hours under temperature of 1250° C., then transfer into a tube furnace roasting for 2 hours under temperature of 1200° C. in 95% N₂+5% H₂ mixed reducing atmosphere; cooling to room temperature, finally obtain the luminescent material Zn_{1.96}SiO₄:Mn_{0.04}@SiO₂@Ag_{2.5×10}⁻⁴.

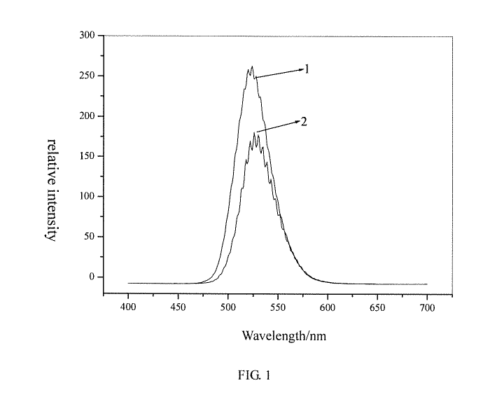

FIG. 1 illustrates a comparison CL emission spectrum of the luminescent materials at the condition of the accelerate voltage is 1.5 kv, one is the spectrum of luminescent material Zn_{1.96}SiO₄:Mn_{0.04}@Ag_{2.5×10}⁻⁴, another is the spectrum of commercial obtained luminescent material Zn₂SiO₄:Mn. According to FIG. 1, around emission peak of wavelength 525 nm, the luminous intensity of the metal coated nano-particle is 45% higher than the commercial obtained material, the luminescent material of the present example has the characteristics of good stability, good color purity, and higher luminous efficiency.

### Example 4

### Preparation of Zn_{1.94}SiO₄:Mn_{0.06}@SiO₂@Pd_{1×10}⁻⁵ by Precipitation Coating Method

Preparation of Pd nano-particle sol: Weigh accurately about 0.22 mg PdCl₂.2H₂O and dissolve into 19.0 ml deionized water; after palladium chloride dissolved thoroughly, weigh accurately about 11.0 mg sodium citrate, 4.0 mg sodium lauryl sulfate, and dissolve into the palladium chloride aqueous solution by magnetic stirring; weigh accurately about 3.8 mg sodium borohydride dissolve into 10.0 ml deionized water to get a sodium borohydride reducing solution with concentration of 1×10⁻² mol/L; with magnetic stirring, fast introducing 1 ml 1×10⁻² mol/L sodium borohydride solution into the palladium chloride aqueous solution, reaction for 20 minutes, and get 20.0 ml Pd nano-particle sol with concentration of 5×10⁻⁵ mol/L; measuring and taking 1.5 ml Pd nano-particle sol with concentration of 5×10⁻⁵ mol/L into a beaker, adding 8 ml PVP solution with concentration of 0.005 g/ml, magnetic stirring for 6 hours, finally get Pd nano-particle after surface treatment.

Preparation of Zn_{1.94}SiO₄:Mn_{0.06}@SiO₂@Pd_{1×10}⁻⁵: By stirring, adding 40.0 ml absolute ethanol, 8.0 ml aqueous ammonia, and 1.8 ml TEOS one after another into the Pd nano-particle sol, and reaction for 5 hours, then adjusting the pH value of the solution with 3.0 to 3.5; introducing 9.7 ml ZnSO₄ with concentration of 1.0 mol/L, 6.0 ml MnSO₄ with concentration of 0.05 mol/L, stirring, and dropping 12.0 ml ammonium oxalate solution with concentration of 1.0 mol/L, then generated white precipitate; then stirring for 3 hours, ageing, filtering, and washing the precipitate by deionized water and absolute alcohol for three times, drying and obtain a premonitory; putting the premonitory into the muffle for heat treatment 4 hours under temperature of 1300° C., then transfer into a tube furnace roasting for 1 hour under temperature of 1300° C. in H₂ reducing atmosphere; cooling to room temperature, finally obtain the luminescent material Zn_{1.95}SiO₄:Mn_{0.05}@SiO₂@Pd_{1×10}⁻⁵.

### Example 5

### Preparation of Zn_{1.80}SiO₄:Mn_{0.20}@SiO₂@Cu_{1×10}⁻⁴ by Precipitation Coating Method

Preparation of Cu nano-particle sol: Weigh accurately about 1.6 mg Cu(NO₃)₂ and dissolve into 16 ml ethyl alcohol; after copper nitrate dissolved thoroughly, introducing 12.0 ml PVP under stirring, then slowly dropping into 4.0 ml sodium borohydride solution with concentration of 1×10⁻³ mol/L; the sodium borohydride solution is acquired by dissolving 0.4 mg sodium borohydride into 10.0 ml deionized water; continue stirring for 10 minutes, and get 20.0 ml Cu nano-particle sol with concentration of 4×10⁻⁴ mol/L; measuring and taking 1.5 ml Cu nano-particle sol with concentration of 4×10⁻⁴ mol/L into a beaker, adding 5.0 ml PVP solution with concentration of 0.03 g/ml, magnetic stirring for 10 hours, finally get Cu nano-particle after surface treatment.

Preparation of Zn_{1.80}SiO₄:Mn_{0.20}@SiO₂@Cu_{1×10}⁻⁴: By stirring, adding 15.0 ml absolute ethanol, 3.0 ml aqueous ammonia, and 1.4 ml TEOS one after another into the Cu nano-particle sol, and reaction for 4 hours, then adjusting the pH value of the solution with 3.0 to 3.5; introducing 18.0 ml Zn(NO₃)₂ with concentration of 0.5 mol/L, 5.0 ml Mn(NO₃)₂ with concentration of 0.2 mol/L, stirring, and dropping 40.0 ml ammonium oxalate solution with concentration of 0.4 mol/L, then generated white precipitate; then stirring for 2.5 hours, ageing, filtering, and washing the precipitate by deionized water and absolute alcohol for three times, drying and obtain a premonitory; putting the premonitory into the muffle for heat treatment 5 hours under temperature of 1100° C., then transfer into a tube furnace roasting for 4 hours under temperature of 1000° C. in 95% N₂+5% H₂ mixed reducing atmosphere; cooling to room temperature, finally obtain the luminescent material Zn_{1.80}SiO₄:Mn_{0.20}@SiO₂@Cu_{1×10}⁻⁴.

### Example 6

### Preparation of Zn_{1.90}SiO₄:Mn_{0.1}@SiO₂@Ag_{5×10}⁻⁴ by Precipitation Coating Method

Preparation of Ag nano-particle sol: Weigh accurately about 0.0429 g AgNO₃, 0.0733 g sodium citrate, and 0.05 g PVP and dissolve into deionized water separately to get 10.0 ml 0.025 mol/L AgNO₃ aqueous solution, 10.0 ml 0.025 mol/L sodium citrate aqueous solution, 10.0 ml 5.0 mg/ml PVP aqueous solution; taking 2.0 ml AgNO₃ aqueous solution and adding into 30.0 ml deionized water, and dropping into 4.0 ml PVP aqueous solution, stirring and heating to temperature of 100° C.; introducing 4.0 ml sodium citrate aqueous solution, after reaction 15 minutes, get 40.0 ml Ag nano-particle sol with concentration of 1×10⁻³ mol/L; measuring and taking 5.0 ml Ag nano-particle sol with concentration of 1×10⁻³ mol/L into a beaker, adding 6 ml PVP solution with concentration of 0.06 g/ml, magnetic stirring for 15 hours, finally get Ag nano-particle after surface treatment.

Preparation of Zn_{1.90}SiO₄:Mn_{0.1}@SiO₂@Ag_{5×10}⁻⁴: By stirring, adding 35.0 ml absolute ethanol, 8.0 ml aqueous ammonia, and 1.5 ml TEOS one after another into the Ag nano-particle sol, and reaction for 2 hours, then adjusting the pH value of the solution with 3.0 to 3.5; introducing 9.5 ml Zn(CH₃COO)₂ with concentration of 2.0 mol/L, 5.0 ml Mn(CH₃COO)₂ with concentration of 0.1 mol/L, stirring, and dropping 30.0 ml ammonium oxalate solution with concentration of 0.5 mol/L, then generated white precipitate; then stirring for 4 hours, ageing, filtering, and washing the precipitate by deionized water and absolute alcohol for three times, drying and obtain a premonitory; putting the premonitory into the muffle for heat treatment 2 hours under temperature of 1300° C., then transfer into a tube furnace roasting for 3 hours under temperature of 1200° C. in 95% N₂+5% H₂ mixed reducing atmosphere; cooling to room temperature, finally obtain the luminescent material Zn_{1.90}SiO₄:Mn_{0.1}@SiO₂@Ag_{5×10}⁻⁴.

### Example 7

### Preparation of Zn_{1.85}SiO₄:Mn_{0.15}@SiO₂@(Ag_{0.5}/Au_{0.5})_{1.25×10}⁻³ by Precipitation Coating Method

Preparation of Ag_{0.5}/Au_{0.5} nano-particle sol: Weigh accurately about 6.2 mg AuCl₃.HCl.4H₂O, 2.5 mg AgNO₃ to dissolve into 28.0 ml deionized water; after dissolved thoroughly, weigh accurately about 22.0 mg sodium citrate and 20.0 mg PVP dissolve into the mixed solution by magnetic stirring; weigh accurately about 5.7 mg sodium borohydride to dissolve into 10.0 ml deionized water, get 10.0 ml sodium borohydride solution with concentration of 1.5×10⁻² mol/L; with magnetic stirring, introducing 2.0 ml 1.5×10⁻² mol/L sodium borohydride solution into the mixed solution, reaction for 20 minutes to get 30.0 ml Ag/Au nano-particle sol with total metal concentration of 1×10⁻³ mol/L; measuring and taking 5.0 ml Ag_{0.5}/An_{0.5} nano-particle sol with concentration of 1×10⁻³ mol/L into a beaker, adding 10.0 ml PVP solution with concentration of 0.1 g/ml, magnetic stirring for 12 hours, finally get Ag_{0.5}/Au_{0.5} nano-particle after surface treatment.

Preparation of Zn_{1.85}SiO₄:Mn_{0.15}@SiO₂@(Ag_{0.5}/Au_{0.5})_{1.25×10}⁻³: By stirring, adding 30.0 ml absolute ethanol, 6.0 ml aqueous ammonia, and 1.0 ml TEOS one after another into the Ag nano-particle sol, and reaction for 5 hours, then adjusting the pH value of the solution with 3.0 to 3.5; introducing 7.4 ml Zn(CH₃COO)₂ with concentration of 1.0 mol/L, 6.0 ml Mn(CH₃COO)₂ with concentration of 0.1 mol/L, stirring, and dropping 20.0 ml ammonium oxalate solution with concentration of 0.5 mol/L, then generated white precipitate; then stirring for 3 hours, ageing, filtering, and washing the precipitate by deionized water and absolute alcohol for three times, drying and obtain a premonitory; putting the premonitory into the muffle for heat treatment 4 hours under temperature of 1250° C., then transfer into a tube furnace roasting for 3 hours under temperature of 1250° C. in 95% N₂+5% H₂ mixed reducing atmosphere; cooling to room temperature, finally obtain the luminescent material Zn_{1.85}SiO₄:Mn_{0.15}@SiO₂@(Ag_{0.5}/Au_{0.5})_{1.25×10}⁻³.

The above-mentioned silicate luminescent material, by coating metal particle to form a core-shell structure, improves inner quantum efficiency of the silicate, and by adding metal nano-particles, strengthens luminous intensity of the silicate; furthermore, the luminescent material has good stability, has spherical morphology, and the size and morphology can be controlled; as spherical morphology has higher bulk density, it is facilitate in coating and improves the display effect.

At the same time, by using the aforesaid precipitation method, it can get epigranular, core-shell structured, spherical morphology of luminescent material; and by this method, it reduces reaction temperature, simplifies preparation technology, decreases equipment requirements, and no pollution, easy to control.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. A silicate luminous material which is represented by the following chemical formula:
Zn₂₋ₓSiO₄:Mnₓ@SiO₂@M_{y}, wherein @ is coating, M is inner core, SiO₂ is middle shell, Zn₂₋ₓSiO₄:Mnₓ is outer shell; M is a metal selected at least one from the group consisting of Ag, Au, Pt, Pd and Cu; y is molar ratio of M to Si in the silicate luminous material; and, the scope of x is: 0<x≦0.2, the scope of y is 0<y≦1×10⁻².

2. The silicate luminous material according to claim 1, wherein the scope of x is 0.02≦x≦0.10, the scope of y is 1×10⁻⁵≦y≦5×10⁻³.

3. A preparation method of a silicate luminous material, comprising the steps of:
A. mixing a salt solution containing M, an addition agent solution for stabilizing and dispersing, and a reducing agent solution, reacting to obtain a collosol containing M nano-particle; and M is a metal selected at least one from the group consisting of Ag, Au, Pt, Pd and Cu;
B. adding the collosol containing M nano-particle into PVP aqueous solution for M nano-particle surface treating, then coating SiO₂ nanosphere by StÖmethod, to obtain a SiO₂@M sol suspension;
C. introducing a Zn salt solution and a Mn salt solution into the SiO₂@M sol suspension, the amount of Zn and Mn element is accorded to stoichiometric ratio of chemical formula Zn₂₋ₓSiO₄:Mnₓ@SiO₂@M_{y}, and the scope of x is 0.02≦x≦0.10, the scope of y is 1×10⁻⁵≦y≦5×10⁻³;
and, adding a precipitating agent into the suspension, then filtering, washing and drying the generated precipitate, to obtain a precursor; drying the precursor for 2 to 10 hours, and heat treatment in reducing atmosphere, then cooling to obtain the silicate luminous material Zn₂₋SiO₄:Mnₓ@SiO₂@M_{y}; wherein @ is coating, M is inner core, SiO₂ is middle shell, Zn₂₋SiO₄:Mnₓ is outer shell.

4. The preparation method according to claim 3, wherein step A further includes the step of preparing the salt solution containing M:
providing raw material of M-salt, adding into deionized water or ethanol, then stirring to obtain the salt solution containing M with concentration from 1×10⁻³ mol/L to 5×10⁻³ mol/L; the raw material of M-salt is selected at least one from the group consisting of AgNO₃, AuCl₃.HCl.4H₂O, H₂PtCl₆.6H₂O, PdCl₂.2H₂O, and Cu(NO₃)₂.

5. The preparation method according to claim 3, wherein in step A, the addition agent is selected at least one from the group consisting of PVP, sodium citrate, cetyltrimethyl ammonium bromide, sodium dodecyl sulfate, and sodium dodecyl sulfonate; and the content of addition agent in the collosol containing M nano-particle is from 1×10⁻⁴ g/ml to 5×10⁻² g/ml; and, the concentration of the reducing agent solution is from 1×10⁻⁴ mol/L to 1.0 mol/L, the reducing agent is selected at least one from the group consisting of hydrazine hydrate, ascorbic acid, sodium citrate, and sodium borohydride; and the molar ratio of reducing agent to M is from 3.6:1 to 18:1.

6. The preparation method according to claim 3, wherein in step B, the concentration of the PVP aqueous solution is from 0.005 g/ml to 0.1 g/ml;
further in step B, the processing of coating SiO₂ nanosphere by StÖmethod including: adding absolute ethanol, deionized water, aqueous ammonia, and TEOS one after another into the collosol containing M nano-particle, stirring to obtain the SiO₂@M sol suspension.

7. The preparation method according to claim 3, wherein in step C, prior to introducing a Zn salt solution and a Mn salt solution into the SiO₂@M sol suspension, pH value of the SiO₂@M sol suspension is adjusted to 3.0 to 3.5.

8. The preparation method according to claim 3, wherein in step C, the Zn salt solution is selected from the group of Zn solution consisting of nitrate, acetate, sulfate, and hydrochloride; the Mn salt is selected from the group of Mn solution consisting of nitrate, acetate, sulfate, and hydrochloride;
the stoichiometric ratio of Zn and Mn to Si is (Zn+Mn):Si≦1:2; the precipitating agent is ammonium oxalate, the amount of ammonium oxalate is 125% to the total moles of Zn₂₋SiO₄:Mnₓ@SiO₂@M_{y}suspension.

9. The preparation method according to claim 3, wherein in step S3, the heat treatment is under temperature around 1000° C. to 1300° C., and treating for 1 to 6 hours.

10. The preparation method according to claim 3, wherein the reducing atmosphere is selected from the group consisting of N₂ and H₂ mixed reduction atmosphere, CO reduction atmosphere, and H₂ reduction atmosphere.
